(19) United States
(12) Patent Application Publication
(10) Pub. No.: US 2021/0355340 A1
(43) Pub. Date: Nov. 18, 2021

(54) LATEX COMPOSITION CONTAINING AN AMINOSILANE AND AN ANION EXCHANGE RESIN

(71) Applicants: Rohm and Haas Company, Collegeville, PA (US); Dow Global Technologies LLC, Midland, MI (US)

(72) Inventors: Azize Ala, East Norriton, PA (US); Gary W. Dombrowski, Chester Springs, PA (US); Patrick E. Hartnett, Malvern, PA (US); Ozzie Moore Pressley, Collegeville, PA (US); Andrew J. Swartz, Fleetwood, PA (US); Qing Zhang, Collegeville, PA (US)

(21) Appl. No.: 17/277,838

(22) PCT Filed: Oct. 8, 2019
(86) PCT No.: PCT/US2019/055086

§ 371 Date: Mar. 19, 2021

Related U.S. Application Data
(60) Provisional application No. 62/742,633, filed on Oct. 8, 2018.

(51) Int. Cl. C09D 133/06; C09D 7/65; C09D 7/63; C09D 5/02

(52) U.S. Cl. CPC C09D 133/064; C09D 5/028; C09D 7/63; C09D 7/65

(57) ABSTRACT

The present invention relates to a composition comprising an aqueous dispersion of polymer particles; b) anion exchange resin particles; and c) an aminosilane. The composition achieves a more desirable balance of stain blocking and stain removal properties in pigmented coating formulations over compositions that contain the latex and the aminosilane but no anion exchange resin, or the latex and the ion exchange resin but no aminosilane.

### BACKGROUND OF THE INVENTION

The present invention provides an aqueous coating composition comprising an anion exchange resin, a latex, and an aminosilane; the composition is useful for delivering stain blocking and stain removal.

Historically, reactive pigments such as ZnO or barium metaborate, or other cationic additives have been used to improve stain blocking in films prepared from waterborne coating compositions. It is believed that these pigments bind stain molecules, which are typically anionic, thereby preventing stains from leeching through the film; however, according to U.S. Pat. No. 5,527,619 (Rokowski) reactive pigments “can cause stability problems, such as viscosity increase and polymer gelation, and are known to be environmentally unfriendly.”

Stain blocking is especially challenging when the formulator also wants to achieve stain removal: Improvement in one property tends to be at the expense of the other; nevertheless, this balance has not been a concern until recent years, where the development of a paint-and-primer-in-one formulation requires delivery of both excellent stain blocking and stain removal.

U.S. Pat. No. 8,815,997 B2 (Zhang) discloses an aqueous dispersion of phosphorus acid functionalized polymer particles in combination with anion exchange resin (IER) copolymer beads suitable for paint-and-primer-in-one applications with improved stain blocking;

nevertheless, Zhang's compositions fail to provide acceptable stain-blocking without compromising stain-removal.

Other efforts directed toward improving stain blocking have focused on improving the barrier properties of the coating through the use of hydrophobic and low molecular weight emulsion polymers. These attempts have been only partially successful; achieving stain block performance equivalent to solvent-based alkyd resins has remained elusive.

It would therefore be advantageous to discover a waterborne coating composition that is effective for improving block resistance and stain removal in coatings formulation.

### SUMMARY OF THE INVENTION

The present invention addresses a need in the art by providing a composition comprising a) an aqueous dispersion of polymer particles having an average particle size in the range of from 50 nm to 500 nm; b) from 0.01 to 7 weight percent, based on the weight the polymer particles, of anion exchange resin particles having an average particle size in the range of from 0.1 μm to 50 μm; and c) from 0.05 to 5 weight percent, based on the weight of the polymer particles, of an aminosilane, which is a compound that contains a primary, a secondary, or a tertiary amino group, or a quaternary ammonium group separated by 2 to 6 carbon atoms from an Si—O group, or a group that is hydrolyzable to an Si—O group. The composition of the present invention provides effective stain blocking and stain removal for coatings formulations.

### DETAILED DESCRIPTION OF THE INVENTION

The present invention is a composition comprising a) an aqueous dispersion of polymer particles having an average particle size in the range of from 50 nm to 500 nm; b) from 0.01 to 7 weight percent, based on the weight the polymer particles, of anion exchange resin particles having an average particle size in the range of from 0.1 μm to 50 μm; and c) from 0.05 to 5 weight percent, based on the weight of the polymer particles, of an aminosilane, which is a compound that contains a primary, a secondary, or a tertiary amino group, or a quaternary ammonium group separated by 2 to 6 carbon atoms, preferably 3 carbon atoms, from an Si—O group or a group that is hydrolyzable to an Si—O group.

The polymer particles preferably have an average particle size in the range of from 70 nm to 300 nm. As used herein, average particle size, with respect to the dispersed polymer particles, refers to the z-average particle size as measured by a Brookhaven BI90 particle size analyzer or a comparable dynamic light scattering instrument. In another embodiment of the present invention, the dispersion of polymer particles comprises a bimodal distribution: one mode in the range of 60 nm to 100 nm, and the other mode in the range of 180 nm to 300 nm.

The aqueous dispersion of polymer particles (the latex) includes a wide variety of latexes such as acrylic, styrene-acrylic, and vinyl ester based latexes. The solids content of the latex is preferably in the range of from 35, more preferably from 40 weight percent, to 55, more preferably to 50 weight percent.

In one embodiment of the present invention the polymer particles are functionalized with from 0.2 to 5 weight percent structural units of a phosphorus acid monomer, based on the weight of the polymer particles. The term “structural unit” of the named monomer refers to the remnant of the monomer after polymerization. Suitable phosphorus acid monomers include phosphonates and dihydrogen phosphate esters of an alcohol in which the alcohol contains or is substituted with a polymerizable vinyl or olefinic group. Preferred dihydrogen phosphate esters are phosphates of hydroxyalkylacrylates and hydroxyalkylmethacrylates, including phosphoethyl methacrylate and phosphopropyl methacrylate, with phosphoethyl methacrylate being especially preferred. Phosphoethyl methacrylate (PEM) is used herein to refer to the following structure:

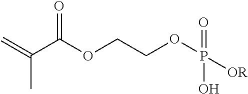

where R is H or

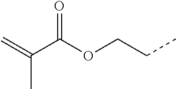

Another class of suitable phosphorus acid monomer is an allyl ethylene oxide phosphate of the following formula:

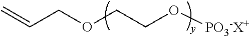

where y is from 3 to 5 and X is Li, Na, K, or NH₄⁺. A commercially available example of an allyl ethylene oxide phosphate is Sipomer PAM-5000 monomer.

Anion exchange resin particles are water-insoluble particles, preferably water-insoluble porous particles, functionalized with basic groups that are capable of exchanging anions.

Examples of suitable basic groups include amines, quaternary ammonium salts, and aminophosphonic groups. Examples of anion exchange resins include polystyrene, polyacrylic, or phenol formaldehyde resins crosslinked with a suitable crosslinking agent such as divinyl benzene or allyl methacrylate. Commercial examples of anion exchange resins include DOWEX™ 1X2 Resin and AMBERLITE™ IRA-900 Cl Resin, both of which are polystyrene-divinyl benzene anion exchange resins functionalized with quaternary ammonium chloride.

The concentration of the anion exchange resin in the composition is preferably in the range of from 0.1, more preferably from 0.3 to 5, more preferably to 3 weight percent, based on the weight of the polymer particles. The anion exchange resin particles preferably have an average particle size in the range of from 0.75 μm, more preferably from 1 μm, and most preferably from 2 μm, to 20 μm, more preferably to 10 μm; as used herein average particle size for the anion exchange resin is the D50 median particle size diameter as measured using a Mastersizer 3000 Particle Size Analyzer, or a comparable laser light scattering device.

The aminosilane is a compound that contains a primary, a secondary, or a tertiary amino group, or a quaternary ammonium group separated by 2 to 6 carbon atoms, preferably 3 carbon atoms, from an Si—O group or a group that is hydrolyzable to an Si—O group (such as an SiH or SiCl group). More preferably, the aminosilane is illustrated by the following structure:

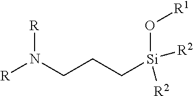

where each R is independently H, C₁-C₃-alkyl, phenyl, or 2-aminoethyl; R¹ is C₁-C₃-alkyl or C(O)CH₃; and each R² is independently H, C₁-C₃-alkyl, C₁-C₃-alkoxy, or O—C(O)CH₃.

Examples of suitable aminosilanes include N-methylaminopropyltrimethoxysilane, 2-aminoethyl-3-aminopropylmethyldimethoxysilane, aminopropyldimethylethoxysilane, N-2-aminoethyl-3-aminopropyltrimethoxysilane, 3-aminopropylmethyldimethoxysilane, 3-aminopropyltriethoxysilane, 3-aminopropyltrimethoxysilane, and N,N-dimethylaminopropyltrimethoxysilane.

The composition of the present invention is especially useful in providing stain blocking in pigmented coating compositions, for example, latex compositions that further comprise TiO₂. The composition advantageously further comprises a pigment, a rheology modifier and one or more additives selected from the group consisting of dispersants, surfactants, neutralizing agents, defoamers, extenders, opaque polymers, and coalescents.

It has been surprisingly been discovered that an aqueous composition comprising the combination of an aminosilane, and anion exchange resin, and a latex shows significant improvement in stain removal and stain blocking balance over compositions that comprise the latex and the aminosilane but no anion exchange resin, or the latex and the ion exchange resin but no aminosilane. It has further been discovered that polymer particles functionalized with a phosphorus acid monomer, preferably PEM, further improve the balance of stain blocking and stain resistance.

### Comparative Example 1

### Preparation of a Latex

A monomer emulsion (ME1) was prepared from deionized water (670 g), Disponil FES 993 emulsifier (FES 993, 22.5 g), butyl acrylate (BA, 825 g), methyl methacrylate (MMA, 645 g), and glacial methacrylic acid (MAA, 30 g). To a 5-L 4-neck flask equipped with a mechanical stirrer, a reflux condenser, a thermocouple, and inlets for monomer emulsion and initiator solution was added deionized water (750 g) and FES 993 (5.77 g). The contents of the flask were stirred and heated to 82° C. A seed charge consisting of a portion of ME1 (76.3 g) was added to the flask followed by an initiator solution consisting of deionized water (10 g) and sodium persulfate (3.75 g). The seed charge and the initiator solution were rinsed to the flask with deionized water. Polymerization of the seed charge was monitored by a thermocouple and when the temperature of the reaction mixture peaked, the remainder of ME1 as well as a second initiator solution consisting of deionized water (200 g), sodium persulfate (0.75 g), and sodium carbonate (10.5 g) were fed into the reactor monotonically over 150 min, while the reactor temperature was controlled at 85° C. After completion of the feeds, the ME1 and initiator solution were rinsed into the flask using deionized water and the reactor was held at 85° C. for 10 min. The reactor was cooled to 80° C., then a solution of ferrous sulfate heptahydrate (0.02 g) and ethylenediaminetetraacetic acid tetrasodium salt (0.02 g) in deionized water (5 g) was added to the flask and rinsed with deionized water. Residual monomer in the reaction mixture was polymerized by feeding a solution of t-butyl hydroperoxide (4 g) in deionized water (20 g); a separate solution of isoascorbic acid (2.2 g) in deionized water (20 g) was added to the flask over 20 min while cooling the reaction mixture to 55° C. After the feeds were complete the reaction mixture was cooled to 30° C. and neutralized to pH 8 using ammonium hydroxide solution. Once neutralized, a solution consisting of KATHON™ LX 1400 Preservative (0.36 g), FES 993 (21.73 g), and deionized water (8.19 g) was added to the flask. The resulting latex was filtered to remove coagulum. The measured solids of the resulting latex was 45.7%.

### Comparative Example 2

### Preparation of a Latex with Ground Ion Exchange Resin

The procedure of Comparative Example 1 was followed except that 0.75% of DOWEX™ 1X2 Ion Exchange Resin, ground to a median particle size of 4-6 μm (as taught in U.S. Pat. No. 8,815,997 B2) was added to the final latex. The chloride form of the resin was used.

### Comparative Example 3

### Preparation of a Latex with an Aminosilane

The procedure of Comparative Example 1 was followed except that 1 weight % 2-aminoethyl-3-aminopropyltrimethoxysilane (2.29 g, 1 weight percent based on latex solids) was added to a portion of the final latex (500 g).

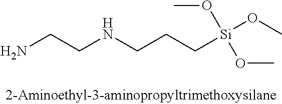

### Example 1

### Preparation of a Latex with Ground Ion Exchange Resin and 2-Aminoethyl-3-Aminopropyltrimethoxysilane

The procedure of Comparative Example 2 was followed except that 1 weight % 2-aminoethyl-3-aminopropyltrimethoxysilane, based on latex solids, was added to the final latex.

### Comparative Example 4

### Preparation of a PEM-Functionalized Latex

The procedure was carried out as described in Comparative Example 1 except that the monomers composing ME1 were BA (825 g), MMA (637.5 g), and phosphoethyl methacrylate (PEM, 60% active, 22.5 g), and the second initiator solution was composed of sodium persulfate (0.75 g) and sodium carbonate (2.5 g) in deionized water (200 g).

### Comparative Example 5

### Preparation of a PEM-Functionalized Latex with Ground Ion Exchange Resin.

The procedure of Comparative Example 4 was followed except that 0.75% of Dowex 1X2 ion exchange resin, ground to a median particle size of 4-6 μm (as taught in U.S. Pat. No. 8,815,997 B2) was added to the final latex. The chloride form of the resin was used.

### Comparative Example 6

### Preparation of a PEM-Functionalized Latex with an Aminosilane

The procedure of Comparative Example 4 was followed except that 1 weight % 2-aminoethyl-3-aminopropyltrimethoxysilane, based on latex solids, was added to the final latex.

### Example 2

### Preparation of a PEM-Functionalized Latex with Ground Ion Exchange Resin and 2-Aminoethyl-3-Aminopropyltrimethoxysilane

The procedure of Comparative Example 5 was followed except that 1% 2-aminoethyl-3-aminopropyltrimethoxysilane, based on latex solids, was added to the final latex.

Paint formulations (Comparative Examples 1a-6a, and Examples 1a-2a) were prepared as shown in Table 1 by adding the components to a container in the order listed. The amounts used were the same for formulations prepared using the binder from Comparative Examples 1-6 and Examples 1-2 except where indicated. PVC refers to pigment volume concentration. RM-3000 refers to ACRYSOL™ RM-3000 Rheology Modifier; Ultra EF refers to ROPAQUE™ Ultra EF Opaque Polymer; RM-995 refers to ACRYSOL™ RM-995 Rheology Modifier; Dispersant refers to TAMOL™ 2011 Dispersant (ROPAQUE, TAMOL and ACRYSOL are trademarks of The Dow Chemical Company or its Affiliates).

TABLE 1
Interior Semi-Gloss Paint Formulation

| | Wt | Level | |
|---|---|---|---|
| Material Name | (g) | (%) | PVC |
| Grind | | | |
| Kronos 4311 TiO₂ | 310.02 | | 19.92 |
| Dispersant | 6 | 0.6 | |
| AMP-75 | 0.6 | | |
| 15-S-40 (20%) | 20.01 | | |
| A-2434 | 1.00 | | |
| RM-3000 | 15 | | |
| Minex 10 Extender | 18.62 | | 2.37 |
| ASP-170 Extender | 18.62 | | 2.40 |
| Letdown | | | |
| Latex | * | | |
| Water | 50.02 | | |
| Add Grind Here | | | |
| Ultra EF | 20 | | 3.3 |
| A-2434 | 0.5 | | |
| Propylene Glycol | 6 | | |
| Texanol | 5.02 | 2 | |
| RM-3000 | * | | |
| RM-995 | * | | |
| Water | * | | |

The amounts of the final water addition, binder, ACRYSOL™ RM-3000 Rheology Modifier and ACRYSOL™ RM-995 Rheology Modifier used in the semi-gloss formulation are shown in Table 2.

TABLE 2
Semi-gloss Paint Formulations

| | Water | Latex | RM-995 | RM-3000 | |
|---|---|---|---|---|---|
| Latex Ex. # | (g) | (g) | (g) | (g) | Paint Ex. # |
| Comp. 1 | 36.4 | 535.7 | 5.6 | 20 | Comp. 1a |
| Comp. 2 | 9.25 | 548.9 | 5.6 | 20 | Comp. 2a |
| Comp. 3 | 33.4 | 526.4 | 5.2 | 24 | Comp. 3a |
| Ex. 1 | 29.4 | 546.4 | 5.2 | 28 | Ex. 1a |
| Comp. 4 | 41.4 | 535.7 | 2.4 | 19 | Comp. 4a |
| Comp. 5 | 42.2 | 546.4 | 2.4 | 18 | Comp. 5a |
| Comp. 6 | 42.9 | 535.7 | 2.4 | 17 | Comp. 6a |
| Ex. 2 | 42.2 | 540.4 | 2.4 | 18 | Ex. 2a |

Marker Stain Blocking Test:

A flat interior test paint was drawn down with a 75-μm (3-mil) Bird film applicator over white Leneta Penopac WB plain white chart and dried for 7 d at 25° C. and 50% relative humidity. A marker stain (Blue Hydrophilic Crayola Washable Marker) was applied to a dried film across the width of the film and the marker was allowed to dry for 4 d. To assess marker stain blocking, a drawdown of the test paint and the control paint were made side-by-side perpendicular to the marker stain using a 75-μm (3-mil) Bird film applicator, and the film was allowed to dry overnight; then a second coat was similarly applied using a 178-μm (7-mil) “U” shaped straddle bar film applicator, and then the film was allowed to dry overnight.

Marker stain blocking was measured using an X-Rite Spectrophotometer Model Ci7. This equipment was used to measure the color change of the unstained and stained area of the substrate which was covered by the paint coating as described above. The value used to express the degree of marker stain blocking is Delta E (ΔE), which is the total color difference represented by a factual sum of ‘L’, ‘a’, and ‘b’ values such that:

ΔE=(Δ_{L}²+Δₐ²+Δb²)^{1/2}

is a measure of color intensity; L=100 is equivalent to white, and L=0 is equivalent to black; “a” is a measure of the red and green color hues, wherein positive equates to red and negative equates to green; “b” is a measure of yellow and blue color hues, wherein positive equates to yellow and negative equates to blue. When measuring ΔE of the test paints and controls, lower ΔE indicate better marker stain blocking performance

Stain Removal Test:

The stain removal test was carried out in accordance with AS™ Method D4828.

Table 3 illustrates stain blocking for blue marker and stain removal for red wine for binder functionalized with MAA.

TABLE 3
ΔE Marker Stain Blocking and Stain Removal Results
of Paint Coatings with Binders Functionalized with MAA

| | ΔE Blue Marker | ΔE Red Wine |
|---|---|---|
| Examples | Stain Blocking | Stain Removal |
| Comp. 1a | 9.7 | 10.4 |
| Comp. 2a | 5.7 | 10.9 |
| Comp. 3a | 9.9 | 4.0 |
| Ex. 1a | 4.7 | 7.3 |

When anion exchange resin is present in an acrylic binder (Comp. 2a), the stain blocking is improved over Comp. 1a, which does not contain anion exchange resin; however, red wine stain removal for Comp. 2a is not improved over Comp. 1a. Conversely, when the aminosilane is present in an acrylic binder (Comp. 3a), stain removal is significantly improved over Comp. 1a, but stain blocking is not improved.

When both ground ion exchange resin and aminosilane are present in an acrylic binder (Example 1a), stain blocking is further reduced relative to Comparative 2a, revealing a surprising synergistic effect. Additionally, stain removal is significantly better in Example 1a as compared with Comparative 1a; thus, improvement in both stain blocking and stain removal properties are observed both ion exchange resin and aminosilane are present in the formulation.

TABLE 4
ΔE Marker Stain Blocking and Stain Removal Results
of Paint Coatings with Binders Functionalized with PEM

| | ΔE Blue Marker | ΔE Red Wine |
|---|---|---|
| Ex. | Stain Blocking | Stain Removal |
| Comp. 4a | 13.6 | 1.0 |
| Comp. 5a | 5.9 | 1.3 |
| Comp. 6a | 7.4 | 0.7 |
| Ex. 2a | 3.7 | 0.9 |

The data show that when ground anion exchange resin and aminosilane are present in a PEM-functionalized binder Ex. 2a, a balance of superior stain blocking and stain removal properties can be achieved.
What is claimed:

1. A composition comprising a) an aqueous dispersion of polymer particles having an average particle size in the range of from 50 nm to 500 nm; b) from 0.01 to 7 weight percent, based on the weight the polymer particles, of anion exchange resin particles having an average particle size in the range of from 0.1 μm to 50 μm; and c) from 0.05 to 5 weight percent, based on the weight of the polymer particles, of an aminosilane, which is a compound that contains a primary, a secondary, or a tertiary amino group, or a quaternary ammonium group separated by 2 to 6 carbon atoms from an Si—O group, or a group that is hydrolyzable to an Si—O group.

2. The composition of claim 1 wherein the polymer particles are acrylic or styrene acrylic polymer particles, and wherein the aminosilane is represented by the following structure: 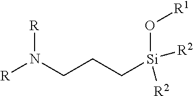
where each R is independently H, C₁-C₃-alkyl, phenyl, or 2-aminoethyl; R¹ is C₁-C₃-alkyl or C(O)CH₃; and each R² is independently H, C₁-C₃-alkyl, C₁-C₃-alkoxy, or O—C(O)CH₃.

3. The composition of claim 2 wherein the aminosilane is represented by the following structure: 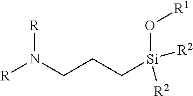
where each R is independently H, C₁-C₃-alkyl, or 2-aminoethyl; R¹ is C₁-C₃-alkyl; and
each R² is independently H, C₁-C₃-alkyl, or C₁-C₃-alkoxy.

4. The composition of claim 3 wherein the anion exchange resin particles are crosslinked porous polymer particles functionalized with an amine or a quaternary ammonium salt.

5. The composition of claim 4 wherein the concentration of the anion exchange resin particles are in the range of from 0.1 to 3 weight percent, based on the weight of the polymer particles; and wherein the anion exchange resin particles are polystyrene-divinyl benzene anion exchange resin particles functionalized with a quaternary ammonium salt.

6. The composition of claim 5 wherein the aminosilane is N-methylaminopropyltrimethoxysilane, 2-aminoethyl-3-aminopropylmethyldimethoxysilane, aminopropyldimethylethoxysilane, N-2-aminoethyl-3-aminopropyltrimethoxysilane, 3-aminopropylmethyldimethoxysilane, 3-aminopropyltriethoxysilane, 3-aminopropyltrimethoxysilane, or N,N-dimethylaminopropyltrimethoxysilane.

7. The composition of wherein the polymer particles are functionalized with from 0.2 to 5 weight percent structural units of a phosphorus acid monomer, based on the weight of the polymer particles.

8. The composition of claim 6 wherein the phosphorus acid monomer is phosphoethyl methacrylate or an allyl ethylene oxide phosphate of the following formula: 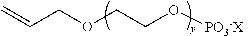
where y is from 3 to 5 and X is Li, Na, K, or NH₄⁺.

9. The composition of claim 8 wherein the phosphorus acid monomer is phosphoethyl methacrylate and the dispersion of polymer particles has a bimodal distribution, having one mode with a volume average particle size in the range of 60 nm to 100 nm and the other mode with a volume average particle size in the range of 180 nm to 300 nm.

10. The composition of claim 2 which further includes a pigment, a rheology modifier, and one or more additives selected from the group consisting of dispersants, surfactants, neutralizing agents, defoamers, extenders, opaque polymers, and coalescents.
